(19) United States
(12) Patent Application Publication
(10) Pub. No.: US 2006/0140644 A1
(43) Pub. Date: Jun. 29, 2006

(54) High performance, high efficiency fiber optic link for analog and RF systems

(76) Inventor: Arthur C. Paolella, Jamison, PA (US)

Correspondence Address: Kenneth Watov;WATOV & KIPNES, P.C., P.O. Box 247, Princeton Junction, NJ, 08550, US

(21) Appl. No.: 11/022,436

(22) Filed: Dec. 23, 2004

(51) Int. Cl. H04B 10/04

(52) U.S. Cl. 398/189

(57) ABSTRACT

A fiber optic link is provided that is receptive of an AM RF input signal, includes an analog comparator for comparing the input signal with a triangle waveform to convert the input signal to a PWM signal. The PWM signal is converted into an optical signal, and transmitted over a fiber optic cable to an optical receiver. The optical receiver converts the optical signal back into a PWM signal, which is amplified via a Class D amplifier. The amplified PWM signal is passed through a low pass filter for converting it into an AM RF output signal having a predetermined power level, the output signal corresponding to the AM RF input signal.

### GOVERNMENT INTEREST

This invention was made with Government support under Contract NRO003-03-C-0301 awarded by the NRO (National Reconnaissance Office). The Government has certain rights in this invention.

### FIELD OF THE INVENTION

The present invention relates generally to communication and radar systems, and more particularly to fiber optic communication systems.

### BACKGROUND OF THE INVENTION

Analog fiber optic links are being deployed in many military and commercial systems for distributing video, radio-frequency, microwave, and millimeter wave signals. Fiber transmission of analog signals is attractive due to design simplicity, wide bandwidth, small size, light weight, immunity to electromagnetic interference, low data loss, and the cost efficiency of fiber optic cables. However, these fiber optic links have significant performance shortfalls such as high insertion loss, inability to transmit high power, limited dynamic range and high power consumption. Proposed techniques to counter the performance shortfalls typically require complex systems and increased consumption of power.

Applications that utilize such distribution networks, including military and medical sensor systems, require efficient transmission for acceptable operation. Space and airborne systems such as unmanned aerial vehicles (UAV), tethered satellites, decoys and space based radar have limited available prime power and required reduced weight and power consumption while the demand for transmission capacity increases. Accordingly, such systems need to be efficient and lightweight.

The low transmission loss and lightweight fiber optics are good qualities desirable for use in military systems such as airborne decoys, antenna remoting systems, and phased array antennas. Fiber optic cables are also used to distribute analog signals for audio, video and radio frequency signals, and remoting of antennas. Fiber optics designed to transmit analog signals exhibit problems including high insertion loss, limited dynamic range, high DC power consumption, and low power added efficiency. Current high frequency analog optical components contribute to these performance problems. Also, they are typically cost prohibitive and must adhere to strict linear performance requirements.

A typical fiber optic link 1, an example being shown in FIG. 1, includes a preamplifier 2, laser transmitter 4, photoreceiver 6, and power amplifier 8, connected in series. A fiber optic cable 10 is connected to carry light signals from laser transmitter 4 to photoreceiver 6. Such fiber optic links 1 typically exhibit a dynamic range of about 100 dB-Hz^{2/3} which may be diminished by laser power, laser noise, modulator non-linearity, and photodetector optical power handling. Insertion loss can typically be as high as 30 dB. Lasers having very high optical power are generally used to enhance the dynamic range and reduce insertion loss of a fiber optic link. Such high optical power is generally in the range of about 225 mW, which limits the power added efficiency (PAE) to about 0.15%. Another approach to reducing link loss is to boost the signal level in photoreceivers 6 using Class A amplifiers in association with the photodetector. However, this approach is limited in that it requires substantial DC power and diminishes PAE to the range of about tenths of a percent.

Analog fiber optic link performance can be further diminished by attenuation and dispersion normally associated with fiber effects. Generally, 1 dB of optical loss translates to 2 dB of RF loss. Dispersion in optical fibers generates distortion which produces wideband performance. A different approach for distributing an RF signal is to digitize the RF signal through use of a high speed analog-to-digital (A/D) converter, transmit the digital bit stream, and thereafter convert back the digital bit stream to an RF signal with a digital-to-analog (D/A) converter. This approach is typically used in cable television systems that operate at 40 MHz to eliminate fiber loss effects and reduce dispersions. These links frequently require complex clock and data recovery chips, expensive A/D and D/A converters, and signal processing chips to enhance the dynamic range, all of which consumes large amounts of power. For higher speeds, optical analog-to-digital converters have been proposed. However, the use of such optical components requires complex and expensive arrangements due to the need to incorporate external modulators to compensate for high optical losses. Pulse width modulation has been proposed for video applications with encouraging results. Pulse width modulation suffers from frequency limitation due largely in part to the presence of the analog to PWM converter, and the power transmission limitation of the associated photoreceivers.

Many of the applications suitable for use with the analog fiber optic technology include space based phased array antennas, power transmission from space, high power transmission of audio, ultrasound, and jamming signals, ultrasound and microwave equipment for imaging, microwave power distribution in catheters, ultra-lightweight systems such as UAV's (unmanned aerial vehicles) and tethered satellites, direction finding (e.g., nulling jammers), communication satellites, and high sensitivity sensors (e.g., pressure, heat and vibration sensors).

Accordingly, there is a need for a fiber optic link system, which can substantially reduce or eliminate link loss, substantially reduce power consumption, substantially increase power-added efficiency, and enhance dynamic range while maintaining desirable cost efficiency. There is a further need for a fiber optic link system that can significantly improve transmission efficiencies in photoreceivers, especially those used in space platforms, and in phased array antennas, which are typically composed of multiple photoreceivers. There is a further need for a fiber optic link system capable of maintaining desirable performance characteristics independent of optical losses typically associated with optical components such as, for example, true time delays; switches, power dividers and isolators.

### SUMMARY OF THE INVENTION

The present invention relates generally to a high performance, high efficiency fiber optic system for distributing analog and RF communications. The system of the present invention utilizes pulse width modulation (PWM) to distribute analog and RF communications with relatively low insertion loss and power consumption while maintaining acceptable dynamic range, improving power added efficiency and overall low operating costs. The system of the present invention functions to convert an analog signal into a pulse width modulated signal that results in significantly reduced fiber dispersion effects, thereby making performance less dependent on transmission distance and optical attenuation. The pulse width modulated signal drives an optical transmitter and is directed to a photoreceiver via a fiber optic cable. The PWM signal output from the photoreceiver is thereafter used to drive an output amplifier, which converts the signal back to analog.

In one embodiment of the present invention, the fiber optic link system of the present invention includes a pulse width generator, a laser transmitter in signal communication with the pulse width generator, a photoreceiver and switching amplifier device in communication with the laser transmitter via a fiber optic cable. The pulse width generator compares the analog input signal against a reference signal to yield an output. The resulting output is a pulse width modulated signal that drives the laser transmitter and is directed to the photoreceiver via the fiber optic cable. The pulse width modulated output is converted to an analog output signal at the receiving end.

### BRIEF DESCRIPTION OF THE DRAWINGS

Various embodiments of the invention are described in detail below with reference to the drawings, in which like items are identified by the same reference designations, wherein:

FIG. 1 is a block schematic diagram of a conventional fiber optic link or communication system for transmitting an analog or RF signal;

FIG. 2 is a block schematic diagram of a fiber optic link or communication system for one embodiment of the present invention;

FIG. 3 is a circuit schematic diagram of a conventional photoreceiver;

FIG. 4 is a circuit schematic diagram of a high efficiency Class E photoreceiver incorporated into the fiber optic link for one embodiment of the present invention;

FIG. 5 is a circuit schematic diagram of a photonic activated Microwave Photonic Amplifier incorporated into the fiber optic link for one embodiment of the present invention;

FIG. 6A is a waveform representation of an input signal in accordance with the present invention;

FIG. 6B is a waveform representation of a switch current in accordance with the present invention;

FIG. 6C is a waveform representation of a capacitor current in accordance with the present invention;

FIG. 6D is a waveform representation of an output signal in accordance with the present invention;

FIG. 7 is a block schematic diagram of a fiber optic link or communication system for another embodiment of the present invention;

FIG. 8 is a simplified representation of a typical pulse width modulation signal generator using a reference signal and an input signal in accordance with the present invention;

FIG. 9 is a screenshot of an oscilloscope display showing a sawtooth reference signal, a sinusoidal input signal, a comparator signal, and a resultant pulse width modulation signal output in accordance with the present invention;

FIG. 10 is a block schematic diagram showing the components for a laser transmitter of the fiber optic link or communication system in accordance with the present invention;

FIG. 11 is a graph showing curves for the fundamental, third and fifth harmonics derived from computer simulated data from a PWM prototype in accordance with the present invention;

FIG. 12 is a graph showing curves for the fundamental, second, third, fourth and fifth harmonics as measured data from a PWM prototype in accordance with the present invention;

FIG. 13A is a time domain graph, from an oscilloscope display, displaying a sawtooth reference signal, a sinusoidal input signal, and a pulse width modulation signal output with the input waveform equal to the triangle waveform in amplitude in accordance with the present invention;

FIG. 13B is a frequency domain graph, from an oscilloscope display, showing the frequency spectrum of the pulse width modulation signal output of FIG. 13A showing the fundamental equal to the 5^{th} harmonic in accordance with the present invention;

FIG. 14A is a time domain graph, from an oscilloscope display, displaying a saw-tooth reference signal, a sinusoidal input signal, and a pulse width modulation signal output with the input significantly lower than the triangle waveform in amplitude in accordance with the present invention;

FIG. 14B is a frequency domain graph, from an oscilloscope display, showing the frequency spectrum of the pulse width modulation signal output of FIG. 14A showing the fundamental lower than the 5^{th} harmonic in accordance with the present invention;

FIG. 15A is a graph displaying a single tone swept input power response for the fundamental, second, third and fourth harmonics for time steps of Tₛ/100 in accordance with the present invention;

FIG. 15B is a graph displaying a single tone swept input power response for the fundamental, second, third and fourth harmonics for time steps of Tₛ/200 in accordance with the present invention;

FIG. 16 is a schematic diagram of a direct RF generating device for converting an optical signal into RF radiation in accordance with the present invention;

FIG. 17 is a perspective view of a three dimensional RF photonic module for use in phased array antennas with a Class E photoreceiver in accordance with the present invention;

FIG. 18 is a block schematic diagram of a phased array antenna with optical distribution in accordance with the present invention;

FIG. 19 is a block schematic representation of a phased array antenna composed of three dimensional modules in accordance with the present invention; and

FIG. 20 is a partial block and circuit schematic diagram of a Microwave Photonic Amplifier for use in one embodiment of the present invention.

### DETAILED DESCRIPTION OF THE INVENTION

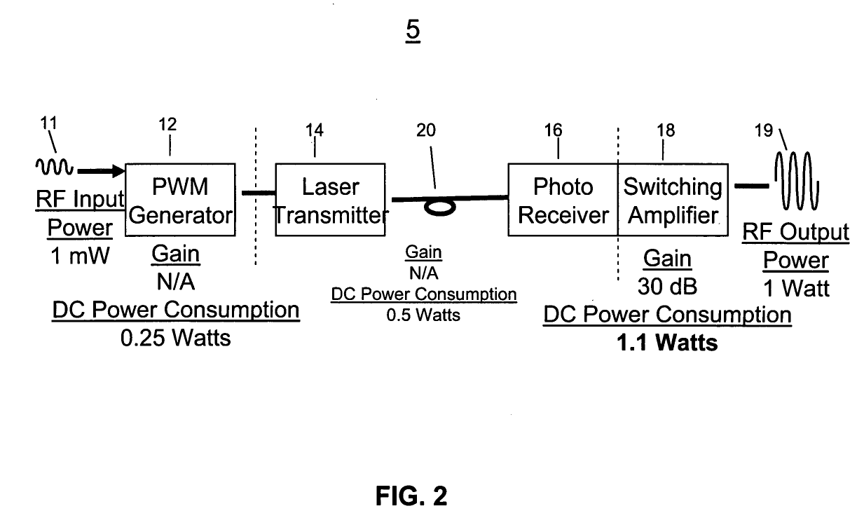

The present invention is directed to a fiber optic link 3 or communication system which exhibits improved performance including reduced RF insertion loss and reduced DC power consumption. The fiber optic link system of the present invention, as shown in FIG. 2, generally includes a pulse width modulation generator 12, a laser transmitter 14, a photoreceiver 16 with a switching amplifier 18, and a fiber optic cable 20 between the laser transmitter 14 and the photoreceiver 16. The system of the present invention is capable of resolving problems typically associated with fiber optics including limited power transmission, high insertion loss, high power consumption and limited dynamic range, while maintaining a relatively simple design and configuration.

The fiber optic link system 5 can be utilized in a range of applications including, but not limited to, space systems such as transmission of power from space, signal distribution in antennas, and tethered satellites, UAVs and airships such as communications and radar signal distribution and links for decoys, radar systems such as microwave power generation, microwave signal transmission, and local oscillator signal transmission, power transmission such as provided via a solar or wind power station, and conversion to microwave signals for free space transmission, medical systems such as catheter and ultrasound, microwave chemistry such as arrays for uniform heating and that is cost effective with circuit and antenna on a single substrate, and industrial and commercial heating.

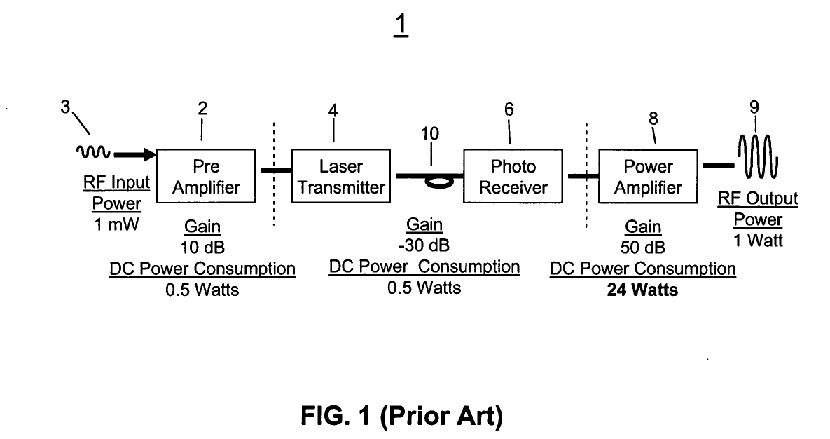

Referring further to FIG. 1, a conventional fiber optic link 1 is shown to illustrate the present state of the art. The conventional fiber optic link includes a preamplifier 2 capable of amplifying an RF input signal 3, a laser or optical transmitter 4 driven by the output signal from preamplifier 2 for outputting an optical signal to a photoreceiver 6 via a fiber optic cable 10, and a power amplifier 8 for amplifying an analog output signal from the photoreceiver 6 to yield an RF output signal 9. In this example, an RF input signal of 1 mW (milliwatt) is applied into preamplifier 2. The output of the preamplifier 2 drives the laser transmitter 4 to generate an analog modulated optical signal. The optical signal is transmitted to the photoreceiver 6 via the fiber optic cable 10, and drives the photoreceiver 6 to generate an RF output signal. The power amplifier 8 receives the RF signal from the photoreceiver 6, and amplifies it to yield an RF output signal of 1 watt, in this example. Also, the preamplifier 2 has a gain of about 10 dB with a DC power consumption of about 0.5 watts, for example. The combination of the laser transmitter 4 and the photoreceiver 6 have a gain of about −30 dB with a DC power consumption of about 0.5 watts, for example. The power amplifier 8 has a gain of about 50 dB with a DC power consumption of about 24 watts, in this example. Note the gains and power levels given as examples heretofore and hereafter were derived via computer simulation techniques.

Referring further to FIG. 2, an ultralight fiber optic link system 5 is shown for one embodiment of the present invention. The fiber optic link system 5 includes a pulse width modulation generator 12 capable of converting an analog RF and microwave input signal 11 into a pulse width modulated (PWM) signal, a laser or optical transmitter 14 driven by the PWM signal for transmitting a corresponding PWM modulated laser optical signal to a photonic activated amplifier 16, 18 via a fiber optic cable to produce an RF output signal.

The photonic activated amplifier is composed generally of a photoreceiver 16 and a high efficiency switching amplifier 18, for example, a Class D or a Class E amplifier. Conventional photoreceivers and amplifiers consumer significant power. The use of the high efficiency switching amplifiers 18 of the present invention provides a novel photonic activated amplifier 16, 18 design that is simple and exhibits an efficiency at least 90% with a theoretical limit of 100% for Class E amplifiers.

As shown in the example of FIG. 2, an RF input signal having a power level of 1 mW is inputted into a pulse width modulation generator 12 to produce a pulse width modulation RF signal. The pulse width modulation generator has a DC power consumption of about 0.25 watts, for example. The pulse width modulated signal drives the laser transmitter 14 for conversion into a corresponding PWM optical signal. The laser transmitter 14 can have a DC power consumption of about 0.5 watts, in this example. The output signal from the photoreceiver 16 is used to drive the switching amplifier 18 to produce the RF output signal having a power level of 1 watt, in this example. The combination of photoreceiver 16 and switching amplifier 18 have a DC power consumption of about 1.1 watts, in this example.

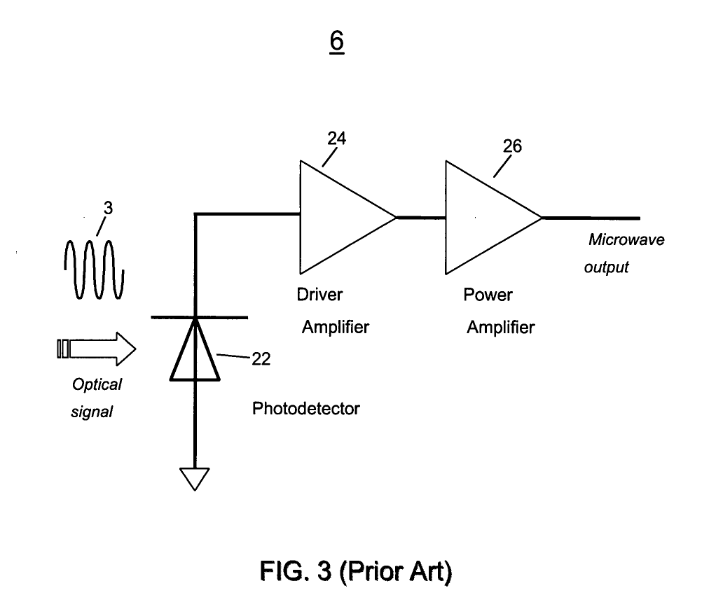

Referring to FIG. 3, a schematic circuit diagram of a conventional photoreceiver, such as photoreceiver 6 of FIG. 1, is shown. The conventional photoreceiver 6 includes a photodetector 22 capable of receiving an analog optical signal 3 for driving a driver amplifier 24 and a power amplifier 26 arranged in series. The conventional photoreceiver 6 generates a microwave output.

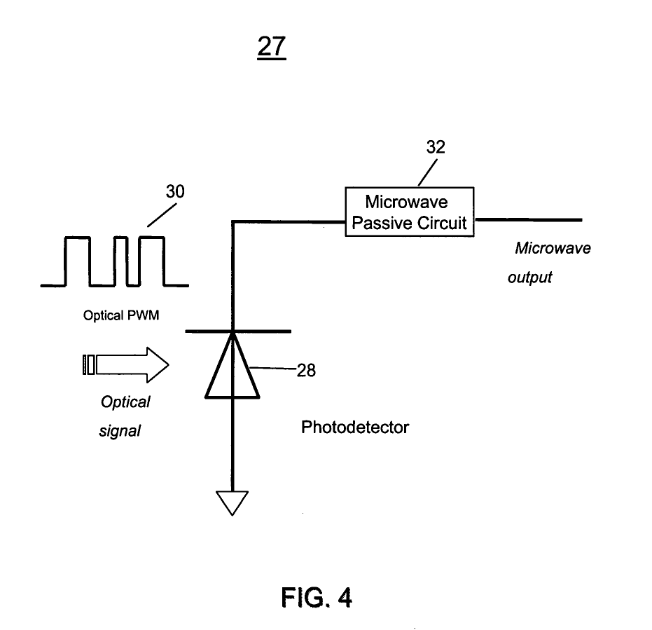

Referring to FIG. 4, a schematic circuit diagram of a photonic activated amplifier 27 is shown to include a high efficiency Class E photoreceiver in one embodiment of the present invention. The photonic activated amplifier 27 includes a photodetector 28 capable of receiving a pulse width modulated optical signal 30, and converting it into a pulsed electrical signal for driving a microwave passive circuit 32. The latter converts the pulsed electrical signal into an analog microwave output signal, and can be used to provide the combination of photoreceiver 16 and switching amplifier 18.

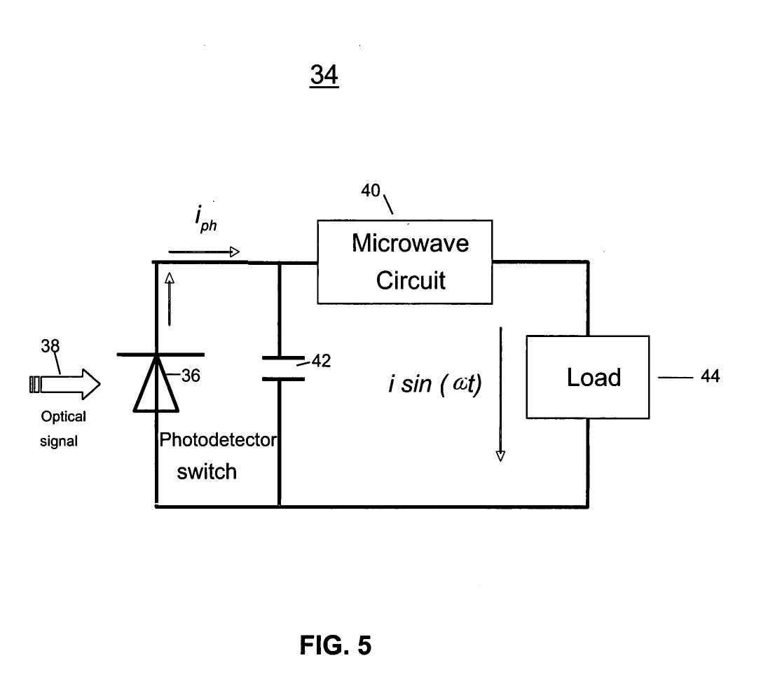

Referring to FIG. 5, a schematic circuit diagram of a Microwave Photonic Activated Amplifier 34 is shown for another embodiment of the present invention. The Microwave Photonic Amplifier 34 includes a photodetector switch 36 capable of receiving a pulse width modulated optical signal 38, for converting it into a pulse width modulated (PWM) electrical signal for driving a microwave passive circuit 40. A capacitor 42 is connected in parallel with photodetector switch 36. The microwave passive circuit 40 converts the PWM electrical signal into an analog output signal across a load 44. The Microwave Photonic Amplifier 34 can be used to provide the combination of photoreceiver 16 and switching amplifier 18 (see FIG. 2).

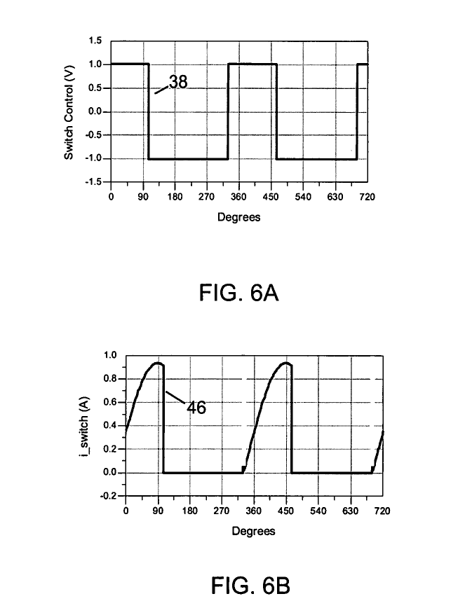

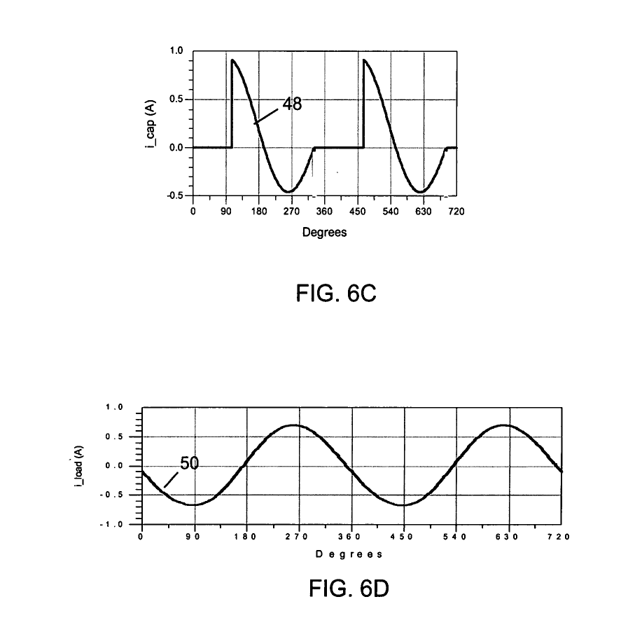

Referring to FIGS. 6A through 6D, computer simulated waveforms showing a pulsed optical signal 38, switch current 46 flowing through switch 36, capacitor current 48 flowing through capacitor 42, and the load current or output signal 50 flowing through load 44, respectively, for the photonic activated Microwave Photonic Amplifier of FIG. 5. Performance results yielded an efficiency of 82%, an input power of zero dBm (1 mW), a comparator DC input of 0.125 volt at zero current, and a radio frequency (RF) power gain of 30 dB (×1000).

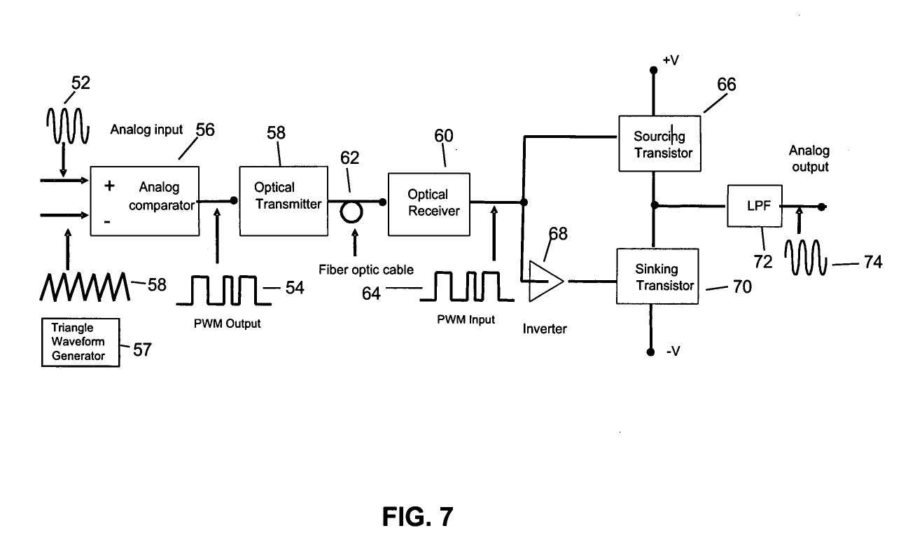

The operation of one embodiment of the invention, as shown in FIG. 7, uses a high efficiency Class D amplifier in a photoreceiver, and the analog input signal 52 is converted into a pulse width modulated (PWM) signal 54. In this manner fiber dispersion effects are significantly reduced, thereby making the analog performance less dependent on transmission distance and optical attenuation, with high dynamic range, as compared to prior analog systems. More specifically, a pulse width generator is provided generally by an analog comparator 56, wherein the analog RF input signal 52 is applied to a non-inverting input, and a reference or sampling signal, such as triangle or sawtooth waveform 58, from a triangle waveform generator 57, is applied to an inverting input. The analog input signal 52 is compared against the sampling signal in the analog comparator 56. The output of the comparator 56 is a pulse width modulated signal 54 that drives the laser or optical transmitter 58, and is directed to a photoreceiver 60 via a fiber optic cable 62. The output signal from optical receiver 60 is applied as a PWM input signal 64 for driving a high efficiency Class D type switching amplifier to convert the signal 64 to an analog form. The high efficiency switching amplifier comprises a sourcing transistor 66 and inverter 68, each for receiving PWM input signal 64. The output of inverter 68 is applied as an input to sinking transistor 70. The sourcing transistor 66 and sinking transistor 70 have their main current paths connected in series between positive (+V) and negative (−V) DC power supplies. The common current in between transistors 66 and 70 provides an output signal that is applied to a low pass filter (LPF), the output of which is an analog signal 74.

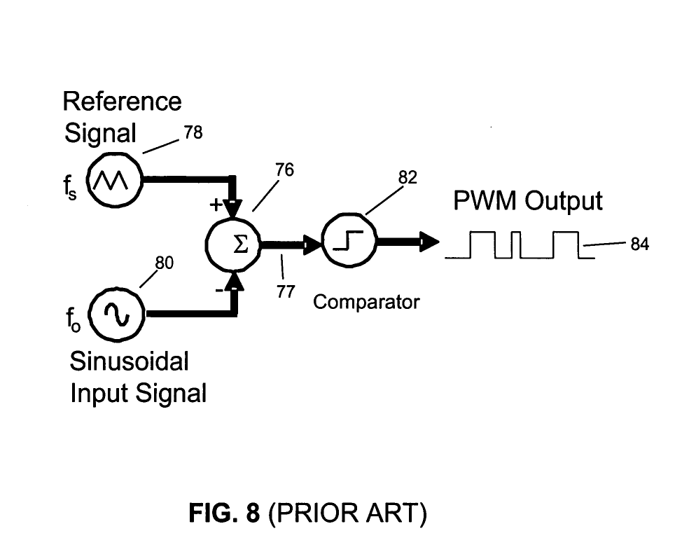

Referring to FIG. 8, a schematic diagram of a conventional pulse width generator is shown. The pulse width generator includes a summer having a non-inverting input for receiving a reference or sampling signal 78 (a triangular waveform in this example), and an inverting input for receiving an input signal 80 (a sinusoidal waveform, for example). The summed signals 77 are inputted to a comparator 82, the output of which is a PWM signal 84.

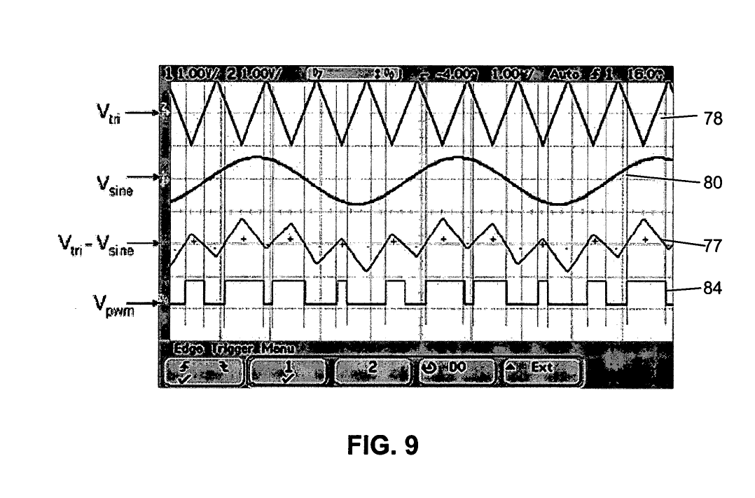

In FIG. 9, an oscilloscope display is shown for an example of waveforms associated with operation of the PWM generator of FIG. 8. Note that the application of a PWM signal to the control electrodes of transistors 66 and 70 is ideally suited for driving the Class D amplifier configuration.

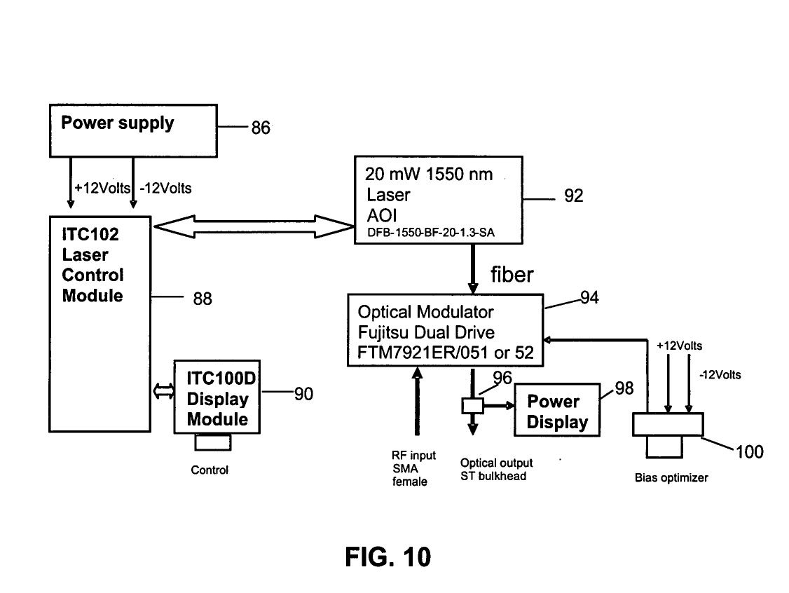

Referring to FIG. 10, a schematic diagram of a conventional laser or optical transmitter is shown that can be used in various embodiments of the present invention. The optical transmitter includes a power supply 86, an ITC102 laser control module 88, an ITC100D display module 90 having a control unit for facilitating the user interface, an AOI DFB-1550-BF-20-1.3-SA laser generator 92 for driving an optical modulator 94 (Fujitsu Dual Drive FTM7921 ER/051 or 52, for example). The optical modulator includes an RF input, and an optical output 96 in communication with a power display 98. The optical modulator is operatively engaged to a bias optimizer. Also, a power supply 100 is shown.

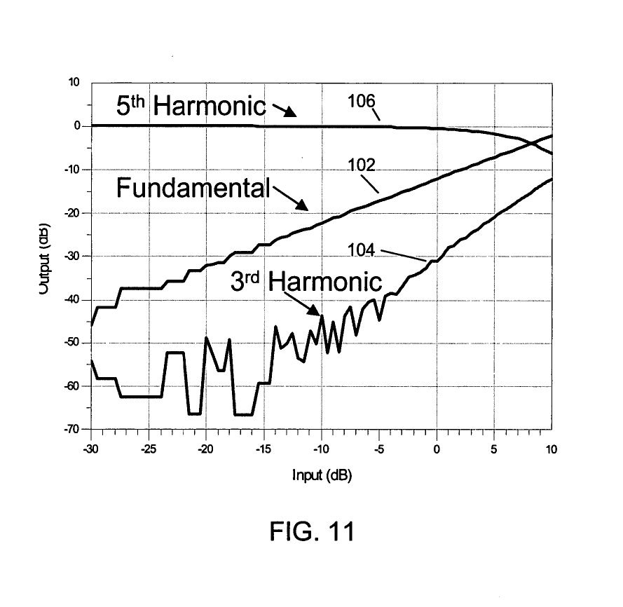

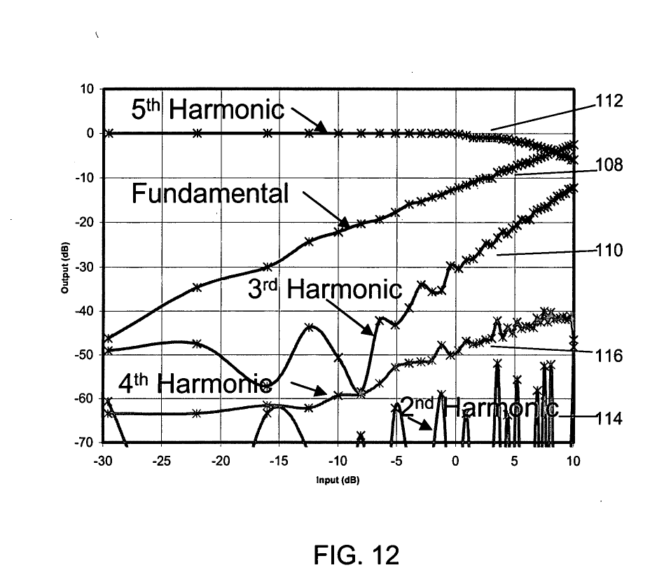

FIG. 11 shows waveforms representing computer simulation of an analog input signal versus a resultant analog output signal, for a fiber optic link of the present invention. Resultant fundamental 102, third harmonic 104, and fifth harmonic 106 waveforms are shown. In FIG. 12, the waveforms obtained from actual measured data from an engineering prototype of a fiber optic link of the present invention, analogous to simulated fiber optic link for FIG. 11, are shown. Note that the measured fundamental 108, third harmonic 110, and fifth harmonic 112 are comparatively similar to analogous simulated waveforms 102, 104, and 106, respectively of FIG. 11. Also, FIG. 12 derived from actual measurements from a prototype of the invention, shows second harmonic 114, and fourth harmonic 116 waveforms. As a result, it is proven that the simulated results of FIG. 11 compare closely with the actual measured results of FIG. 12.

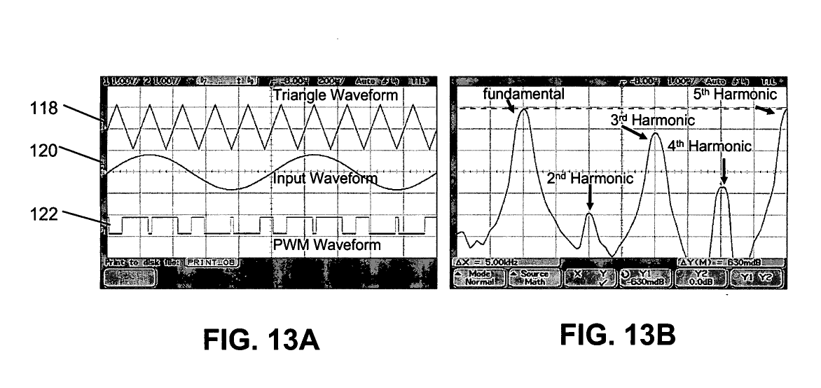

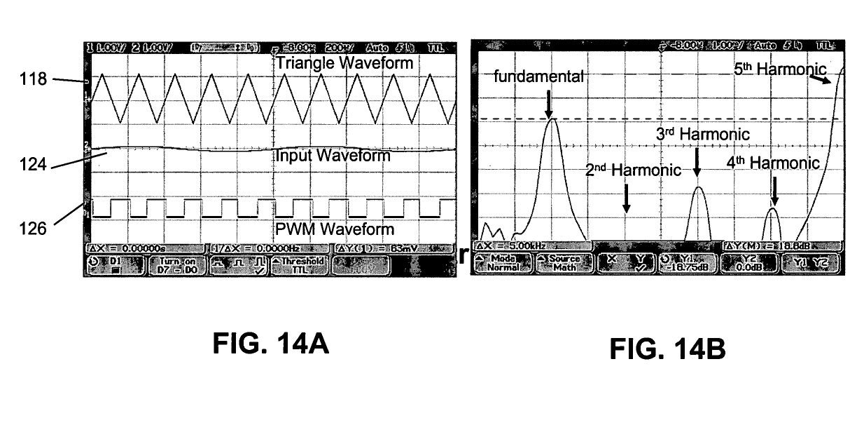

Waveforms derived from measurements for the fiber optic link of FIG. 7 are shown in FIGS. 13A and 13B, for the time domain, and frequency domain, respectively. In FIG. 13A, the triangular waveform 118 has a 1 volt peak value, and the input sinewave 120 has a 0.8 volt peak value. The PWM waveform 122 is the result of combining waveforms 118 and 120 as previously described. In FIG. 13B the frequency spectrum for the PWM waveform 122 is shown. In FIG. 13A, the input signal 120 is of the order of the reference signal 118. Since the sampling rate is five times the frequency of the input signal 120, the fundamental and fifth harmonic are at the same power level as seen in FIG. 13B. In FIG. 14A, the input signal 124 is significantly smaller than the reference signal 118. Since the sampling rate is five times the frequency of the input signal 124, the output signal of the comparator 82 looks similar to a square wave at five times the fundamental. This is proven as shown in FIG. 14B where the fifth harmonic is much greater than the fundamental. These illustrate the dynamic range of the comparator. The waveforms of FIGS. 14A and 14B are also computer simulated relative to FIG. 13A, for FIG. 14A, the triangular waveform 118 is the same. However, the sinusoidal input waveform 124 of FIG. 14A has a 0.1 volt peak, rather than a 0.8 volt peak as for waveform 120 of FIG. 13A. As a result, the PWM waveform 126 of FIG. 14A is different from PWM waveform 122 of FIG. 13A. The frequency spectrum of PWM waveform 126 is shown in FIG. 14B.

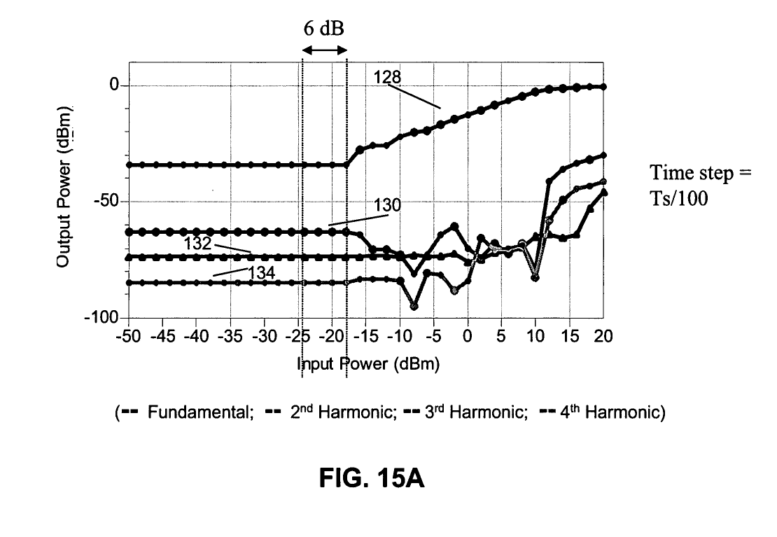

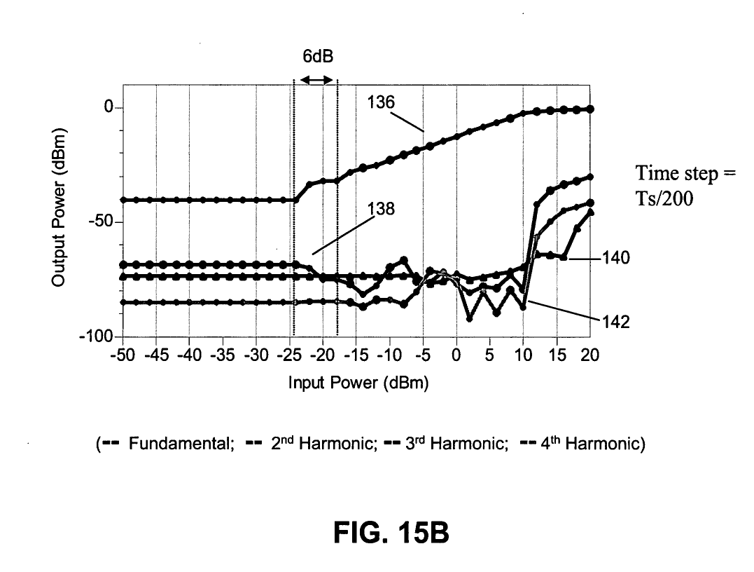

In FIGS. 15A and 15B, actually measured waveforms are shown for the operation of the PWM generator of FIG. 8, for time steps of Ts/100, and Ts/200. Waveforms 132 and 140 are substantially the same for the fundamental frequency waveforms 128 and 136 show the third harmonic, 130 and 138 the second harmonic, and 134 and 142 the fourth harmonic, respectively. From these simulations, it is apparent that time stability/step affects sensitivity response. In this simulation a 6 dB improvement was obtained by doubling the time-step.

The fiber optic link of the present invention, as illustrated and described above with reference to the embodiments of FIG. 7, uses a PWM methodology for converting an electrical analog input signal to a PWM optical signal for transmission over a fiber optic cable 62 to an optical receiver 60. As previously noted, the optical receiver 60 converts the PWM optical signal into a PWM electrical signal for input to a very high efficiency amplifier 68, 66, 70, the output of which is converted by a low pass filter 72 into an electrical analog signal 74. In tests performed using a prototype of the fiber optic link of FIG. 7, only 0.5 watts DC power was required to distribute analog signals over the link with no insertion loss. In comparison, 3.5 watts DC was required in a traditional amplitude modulated (AM) link, and 6.5 watts was required in a known analog-to-digital (A/D) link, to overcome insertion loss. Accordingly, the optical link of the present invention is seven times more efficient than a typical AM based link, and thirteen times more efficient than a typical A/D based link, in distributing analog signals over the associated fiber optic link with no insertion loss.

The embodiment of the invention of FIG. 7 has proven to be directly applicable for use in phased array antennas. As will be further discussed below, such use eliminates fiber optic link insertion loss, reduces DC power consumption, and improves system power added efficiency (PAE).

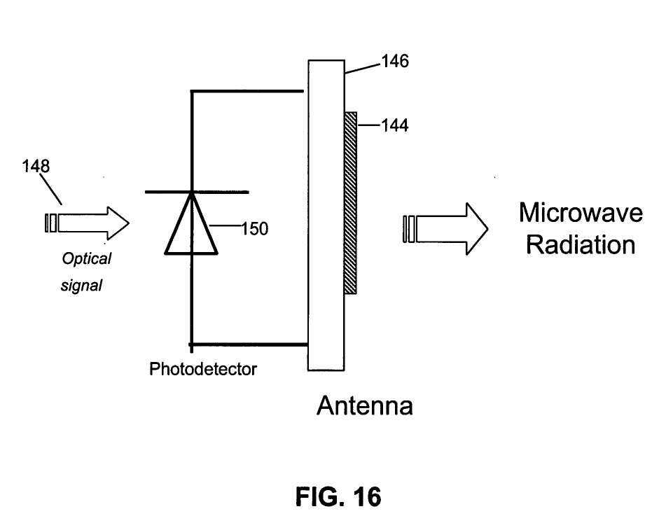

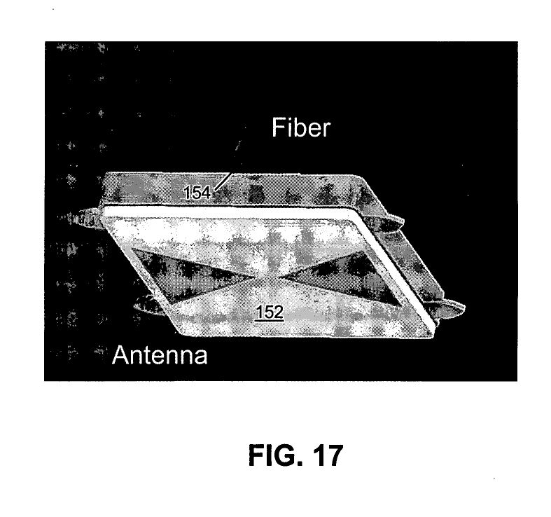

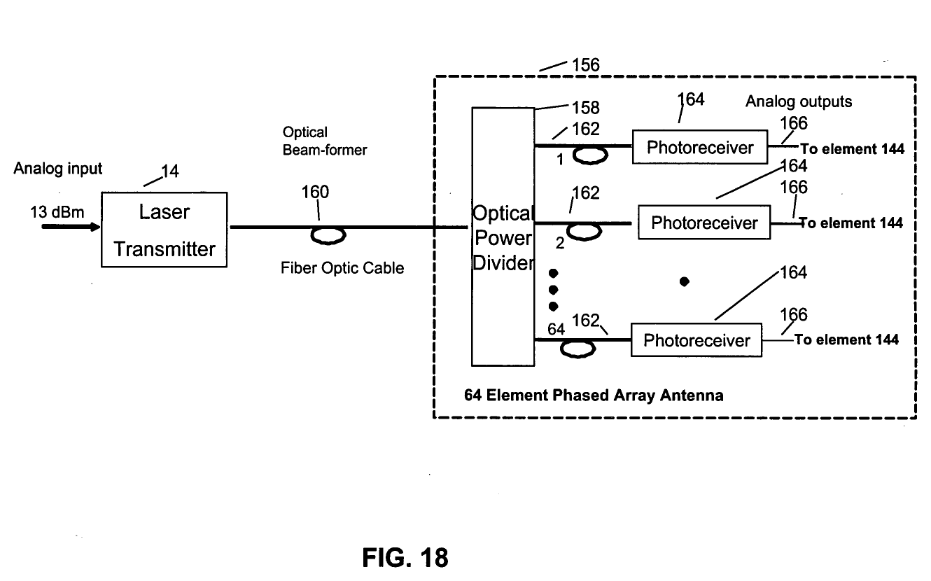

The present inventor used computer simulation to compare the present fiber optic link to use of two known fiber optic link technologies, namely, (1) simple amplitude modulation (AM), and (2) typical analog-to-digital (A/D) conversion, in a sixty four element transmit subarray of a larger phased array antenna for a spacecraft or similar platform. More specifically, in another embodiment of the invention, as shown in FIG. 16, a planar antenna element 144 housed within a 3D module 146 for a phased array antenna 156 (see FIG. 18), is driven via a PWM optical signal 148 that is converted by a photodetector 150 into an electrical PWM signal, the latter being converted into an RF signal using the 3D module 146 and antenna element 144 as an electrical circuit forming a Microwave Photonic Amplifier thus directly driving the module. A module 146 for another embodiment of the invention is contained within a housing 152 of suitable material, such as ceramic or plastic. A fiber optic cable 154 is connected to the back of housing 152 for carrying optical signal 148 to module 146. Each module 146 is made from a dielectric material such as a ceramic or plastic housing, that is part of the RF circuit. Each module 146 is adapted for securely mounting a radiating element 144 thereon.

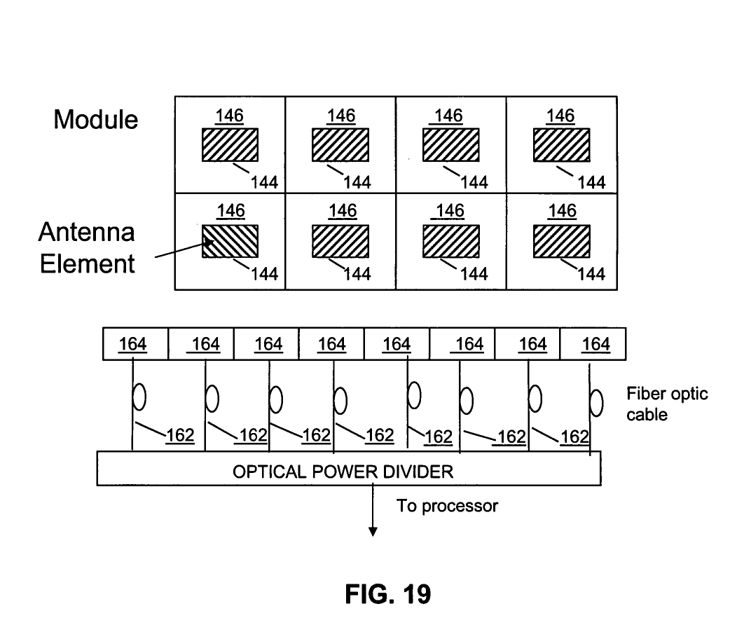

In another embodiment of the invention, as shown in FIG. 18, a sixty four element phased array antenna 156 includes an optical power divider 158 for receiving a 13 dBm RF AM optical signal 148 from a laser/transmitter 14 via a fiber optic cable 160, and dividing the signal equally for respectively driving one end of each of sixty-four fiber optic cables 162. The other ends of the fiber optic cables 162 are each individually connected to the optical input terminals (not shown) of sixty-four identical photoreceivers 164, respectively. In this example, each photoreceiver 164 amplifies and converts the RF AM optical signal into a 13 dBm electrical analog output signal on an associated output line 166 for driving an individual antenna element 144 of the sixty-four elements 144 of the phased array antenna 156. Each output line 166 is individually connected to a different element 144. Note that the present invention is not limited to use with sixty-four element phased array antennas 156, but can be used with phased array antennas having any number of elements. For example, a phased array antenna 168, as shown in FIG. 19, includes eight modules 146 each containing a radiating element 144 driven by the output signal from eight photoreceivers 164, each of the latter being connected by an individual fiber optic cable to an optical power divider 158. A fiber optic cable 160 converts an input of the latter to the output of a laser transmitter 14, in this example.

Note that the phased array antenna 156 is constructed to have a predetermined radiating pattern for RF waves transmitted therefrom. The radiating pattern is at least partly determined by the arrangement of the radiating elements 144.

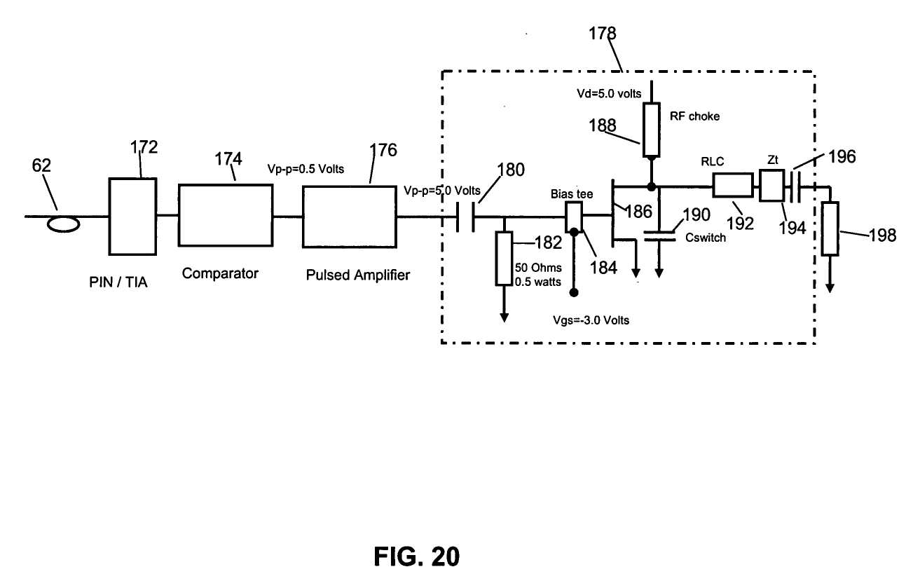

An alternative to the Class D switching amplifier 66, 68, 70, 72 and optical receiver 60 of the embodiments of the invention of FIGS. 2 and 7 is shown in FIG. 20. In this alternative embodiment, the optical signal from fiber optic cable 62 is connected to a photodiode/transimpedance amplifier (PIN/TIA) 172 (see FIG. 20) that converts the PWM optical signal from the fiber 62 into an electrical signal and amplifies it to a useful level. A comparator 174 functions as a limiting amplifier so that the PWM signal has a constant peak voltage of 0.5 Volts independent of the input level from the PIN/TIA 172 to the pulsed amplifier 176. In a prototype system for the present invention, the pulsed amplifier 176 was provided by Mini-Circuits ZPUL-30P amplifier (G=20 dB, P1 dB=20 dBm, Fmax=1 Ghz), for providing Class D amplification to amplify the signal to 5.0 Volts peak to switch the Class E amplifier 178. Class E amplification, in this example, is provided by an AMCOM AM012MX-QG aAS Power FET field effect amplifier 178 (Vds=3V, Idss(mA)=280 mA, Pinch-off Voltage Vp=−2V). Amplifier 178 includes a capacitor 180 and resistor 182 for providing a high pass filter, a bias tee Mini-Circuits TCBT 184 for coupling the output from the high pass filter 180, 182 to the gate of FET 186 (a GaAs Power FET, for example), and pulling down the gate to −3.0 VDC when no signal is present. An RF choke 188 (Mini-Circuits TCCH rated at 100 mA) is connected between +5 VDC and the source of FET 186 and one end of a capacitive C switch 190. The source of FET 186 is connected to ground. The drain is connected to a series RLC Circuit 192, Z impedance 194, and a capacitor 196. The other end of the capacitor 196 provides an output signal, and is connected to a load resistor 198 of fifty ohms. Note that Z impedance 194 matches the output impedance of amplifier 178 to load 198.

Although various embodiments of the invention have been shown and described, they are not meant to be limiting. Those of skill in the art may recognize various modifications to these embodiments, which modifications are meant to be covered by the spirit and scope of the appended claims.

What is claimed is:

1. A fiber optic link comprising:
a pulse width modulator generator for receiving an amplitude modulated (AM) radio frequency (RF) input signal and converting it into a pulse width modulated (PWM) signal;
an optical transmitter for receiving said PWM signal, converting it into an optical output signal;
a first fiber optic cable for receiving said optical output signal at one end and conveying it to another end;
an optical receiver for receiving said optical signal from the said another end of said first fiber optic cable, and converting said optical output signal into an electrical PWM signal; and
a high efficiency high frequency power amplifier for receiving said electrical PWM signal to both amplifier and convert it into an RF output signal having a predetermined wattage.

2. The fiber optic link of claim 1, wherein said optical transmitter is a laser transmitter.

3. The fiber optic link of claim 1, wherein said power amplifier includes:
a Class D amplifier; and
a low pass filter for receiving the amplified electrical PWM signal and converting it into an AM RF output signal.

4. The fiber optic link of claim 3, wherein said power amplifier includes a Microwave Photonic Amplifier.

5. The fiber optic link of claim 3, wherein said Class D amplifier is a switching amplifier.

6. The fiber optic link of claim 3, wherein said Class D amplifier includes:
a sourcing transistor having one end of a main current path connected to a source of positive DC voltage, another end of the main current path providing a portion of the electrical PWM signal, and a control electrode for receiving said electrical PWM signal;
an inverter for inverting said electrical PWM signal;
a sinking transistor having a control electrode for receiving the inverted electrical PWM signal, and a main current path having one end connected to the another end of the main current path of said sourcing transistor, and another end of the main current path of said sinking transistor being connected to a source of negative DC voltage; and
a low pass filter having an input connected to the common connection between the main current paths of said sourcing and sinking transistors, and an output for providing an amplified AM RF output signal.

7. The filter optic link of claim 2, wherein said power amplifier includes:
a Class D amplifier; and
a low pass filter for receiving the amplified electrical PWM signal and converting it into an AM RF output signal.

8. The fiber optic link of claim 7, wherein said power amplifier includes a Microwave Photonic Amplifier.

9. The fiber optic link of claim 7, wherein said Class D amplifier is a switching amplifier.

10. The fiber optic link of claim 7, wherein said Class D amplifier includes:
a sourcing transistor having one end of a main current path connected to a source of positive DC voltage, another end of the main current path providing a portion of the electrical PWM signal, and a control electrode for receiving said electrical PWM signal;
an inverter for inverting said electrical PWM signal;
a sinking transistor having a control electrode for receiving the inverted electrical PWM signal, and a main current path having one end connected to the another end of the main current path of said sourcing transistor, and another end of the main current path of said sinking transistor being connected to a source of negative DC voltage; and
a low pass filter having an input connected to the common connection between the main current paths of said sourcing and sinking transistors, and an output for providing an amplified AM RF output signal.

11. The fiber optic link of claim 1, wherein said PWM generator includes:
a triangle waveform generator for producing a triangular waveform; and
analog comparator means having a non-inverting terminal for receiving said AM RF input signal, an inverting terminal for receiving a triangular waveform, for comparing said AM RF input signal to said triangular waveform for producing said PWM signal.

12. The fiber optic link of claim 1, further including:
a module of a microwave antenna; and
a microwave radiating element contained within said module, whereby said RF output signal is connected to said radiating element.

13. The fiber optic link of claim 1, further including;
a plurality of said fiber optic links each driving an individual one of a plurality of antenna RF radiating elements, respectively, of a phased array antenna.

14. The fiber optic link of claim 13, further including:
a plurality of modules each containing an individual one of said plurality of antenna RF radiating elements, respectively, said modules being connected together in a predetermined manner for providing said phased array antenna.

15. A method for providing a fiber optic link comprising the steps of:
converting an amplitude modulated (AM) radio frequency (RF) input signal into an electrical first PWM signal;
converting the first PWM signal into an optical signal;
transmitting said optical signal over a fiber optic cable;
converting the optical signal from said fiber optic cable back into an electrical second PWM signal;
amplifying said second PWM signal; and
converting the amplified said second PWM signal into an AM RF output signal having a predetermined power level.

16. The method of claim 15, wherein said step of converting said AM RF input signal includes the steps of:
receiving said AM RF input signal;
receiving a triangular waveform; and
comparing in an analog comparator said AM RF input signal to said triangular waveform to produce said first PWM output signal.

17. The method of claim 15, wherein said step of converting said first PWM output signal into an optical signal includes the step of:
applying said first PWM output signal to an input of an optical transmitter, the output of the latter being a corresponding said optical signal.

18. The method of claim 17, wherein said optical transmitter is a laser transmitter.

19. The method of claim 15, wherein said step of converting said optical signal into an electrical second PWM signal includes the step of:
applying said optical signal to the input of an optical receiver, the output of which provides the electrical second PWM signal.

20. The method of claim 15, wherein said step of amplifying said second PWM signal includes the step of:
applying said second PWM signal to the input of a Class D amplifier, the output of which provides the amplified said second PWM signal.

21. The method of claim 15, wherein said step of converting the amplified said second PWM signal into an AM RF output signal includes the step of passing the former through a low pass filter.

22. The method of claim 15, wherein said amplifying step includes the step of passing said second PWM signal through a Microwave Photonic Amplifier

23. An optically driven phased array antenna system comprising:
a plurality of photonic modules;
a plurality of RF radiating elements each mounted in an individual one of said plurality of photonic modules; respectively;
a main fiber optic cable;
means for converting an AM RF input signal into a corresponding first PWM optical signal, for connection to said main fiber optic cable;
optical power divider means for receiving said first PWM optical signal from said main fiber optic cable, for dividing said first PWM optical signal into a plurality of second PWM optical signals each of lower power than but corresponding to said first PWM optical signal;
a plurality of photoreceiver 6 means for converting said plurality of second PWM optical signals into a plurality of RF analog output signals;
a plurality of secondary fiber optic cables connected between said optical power divider and said plurality of photoreceivers, respectively, for transmitting said plurality of second PWM optical signals therebetween; and
a plurality of electrical conductors or cables for conducting said RF analog output signals to said plurality of RF radiating elements, respectively.

24. The phased array antenna of claim 23, wherein said means for converting an AM RF input signal into a corresponding first PWM optical signal includes:
a triangle waveform generator;
an analog comparator means having a non-inverting terminal for receiving said AM RF input signal, an inverting terminal for receiving a triangular waveform, for comparing said AM RF input signal to said triangular waveform for producing said PWM signal.

25. The phased array antenna of claim 23, wherein each one of said photonic modules includes:
a housing of non-electrical conductive material that is part of the RF circuit.

26. The phased array antenna of claim 23, wherein each one of said photoreceiver means includes:
first conversion means for converting an associated one of said plurality of PWM optical signals into a corresponding electrical PWM signal;
amplifying means for amplifying said electrical PWM signal; and
second conversion means for converting the amplified said electrical PWM signal into an AM RF analog output signal having a predetermined power level.

27. The phased array antenna of claim 26, wherein said first conversion means includes a photodetector.

28. The phased array antenna of claim 26, wherein said amplifying means consists of a Class D amplifier.

29. The phased array antenna of claim 26, wherein said second conversion means consists of a low pass filter.

30. The phased array antenna of claim 26, wherein said amplifying means consists of a microwave photonic amplifier.
